(19) United States
(12) Patent Application Publication
(10) Pub. No.: US 2023/0131067 A1
(43) Pub. Date: Apr. 27, 2023

(54) PROCESS FOR DETECTION OF EVENTS OR ELEMENTS IN PHYSICAL SIGNALS BY IMPLEMENTING AN ARTIFICIAL NEURON NETWORK

(71) Applicant: STMicroelectronics (Rousset) SAS, Rousset (FR)

(72) Inventors: Pierre Demaj, Nice (FR); Laurent Folliot, Gourdon (FR)

(21) Appl. No.: 17/968,163

(22) Filed: Oct. 18, 2022

(30) Foreign Application Priority Data
Oct. 25, 2021 (FR) 2111300

(51) Int. Cl. G06N 3/02; G06K 9/00

(52) U.S. Cl. CPC G06N 3/02; G06K 9/00523; G06K 9/00536

(57) ABSTRACT

According to one aspect, a method is proposed for detecting events or elements in physical signals by implementing an artificial neural network. The method includes an assessment of a probability of the presence of the event or the element by an implementation of the neural network. The implementation of the neural network according to a nominal mode takes as input a physical signal having a first resolution, called nominal resolution, when the probability of presence of the event or the element is greater than a threshold. The implementation of the neural network according to a low power mode takes as input a physical signal having a second resolution, called reduced resolution, lower than the first resolution, when the probability of presence of the event or the element is below the threshold.

### CROSS-REFERENCE TO RELATED APPLICATIONS

This application claims priority to French Patent Application No. 2111300, filed on Oct. 25, 2021, which application is hereby incorporated by reference herein in its entirety.

### TECHNICAL FIELD

The present disclosure generally relates to artificial neural networks, and in particular embodiments, to artificial neural networks configured to detect events or elements in physical signals.

### BACKGROUND

Generally, an artificial neural network can be used to detect events or elements in physical signals received at the input of these neural networks. For example, artificial neural networks can take images as inputs and detect events or elements within these images, in particular, to detect objects or people.

The execution of a neural network can involve a significant amount of calculations. However, the greater the number of calculations, the higher the energy consumption resulting from executing the neural network. Therefore, the energy consumption resulting from the execution of a neural network depends on the execution time of the neural network, which is linked to its complexity.

In some applications, neural networks can be implemented by microcontrollers having limited energy autonomy. Indeed, the microcontrollers may not be powered directly by an electrical distribution network but by an autonomous battery with a limited energy storage capacity. For example, the neural networks can be implemented by microcontrollers integrated into connected objects, including batteries, to power these microcontrollers.

It is particularly important in these applications to reduce the energy consumption of the microcontroller implementing the neural network to increase the service life of the battery, such that the microcontroller can be used as long as possible before recharging the battery, or even replacing the device including the microcontroller, which can be impractical and expensive.

It is possible to stop using the neural network during certain periods to reduce the power consumption of the microcontroller. Nevertheless, such a solution does not allow the detection of events or elements in the physical signals received as input during these periods.

It is also possible to simplify the artificial neural network to reduce the calculations performed during the execution of the simplified neural network. For example, quantifying a neural network allows simplifying it. Nevertheless, the simplified neural networks can lead to a loss of performance of the neural network in detecting the events or the elements in the physical signals received as input of this neural network.

Therefore, it is advantageous to propose a solution that reduces the energy consumption of a microcontroller implementing a neural network adapted to detect events or elements while maintaining good detection performance.

### SUMMARY

According to one aspect, a method is proposed for detecting events or elements in physical signals by implementing an artificial neural network, in which the artificial neural network has a single weight set of and is configured to take as input physical signals which can take different resolutions, the neural network capable of being implemented according to: a nominal mode in which the neural network is executed by taking as input a physical signal having a first resolution, called nominal resolution, or a low power mode in which the neural network is executed by taking as input a physical signal having a second resolution, called reduced resolution, lower than the first resolution, the reduced resolution of the input physical signal of the neural network being a multiple of a ratio between the nominal resolution of the input physical signal and an output resolution of the neural network when the physical signal taken as input is of nominal resolution, the method including: an assessment of a probability of presence of the event or the element by an implementation of the neural network, an implementation of the neural network according to the nominal mode when the probability of presence of the event or the element is greater than a threshold, and an implementation of the neural network according to the low power mode when the probability of presence of the event or the element is below the threshold.

The network is then a multi-resolution neural network. This multi-resolution neural network can be implemented by a microcontroller supplied with energy by a battery. Such a neural network is trained by taking as input physical signals of different resolutions, and by assessing the performance of this neural network using the nominal resolution. For example, a multi-resolution neural network for detecting events or elements in an image may take, as input, images of different resolutions.

The energy consumption resulting from the implementation of such a multi-resolution neural network varies depending on the resolution of the input physical signal of the neural network. In particular, the smaller the resolution of the physical input signal, the less the execution of the neural network requires performing calculations before generating data as output of the neural network. Thus, the smaller the resolution of the input physical signal, the lower the energy consumption resulting from the implementation of the neural network.

Thus, in a method according to the invention, the low power mode allows reducing the energy consumption by taking as input a physical signal with reduced resolution relative to the physical signal taken as input in the nominal mode.

The low power mode may be slightly less efficient than the nominal mode. Nevertheless, the low power mode is used only when the probability of the presence of an event or an element is below a certain threshold. If the probability of presence of an event or element is greater than this threshold, the neural network is executed in its nominal mode to improve the detection relative to the low power mode. This allows maintaining good performance in detecting an event or an element. Indeed, the execution of the neural network in the low power mode allows continuing to monitor the presence or the absence of an event or an element while reducing energy consumption. In this manner, it is possible to increase the time of autonomy of the battery powering the microcontroller implementing the neural network. The assessment of the probability of presence of the event or the element is performed regularly after one or more implementations of the neural network according to the nominal mode or according to the low power mode.

Preferably, the threshold is defined according to a sensitivity or a desired accuracy of the neural network.

In an advantageous embodiment, the input physical signal is an image.

According to another aspect, a computer program is proposed including instructions which, when the program is executed by a computer, lead the latter to implement an artificial neural network to detect events or elements in physical signals received as input of this neural network, a program in which the artificial neural network has a single weight set and is configured to take as input physical signals which can take different resolutions, the neural network capable of being implemented according to: a nominal mode in which the neural network is executed by taking as input a physical signal having a first resolution, called nominal resolution, or a low power mode in which the neural network is executed by taking as input a physical signal having a second resolution, called reduced resolution, lower than the first resolution, the reduced resolution of the input physical signal of the neural network being a multiple of a ratio between the nominal resolution of the input physical signal and an output resolution of the neural network when the physical signal taken as input is of nominal resolution, and wherein the program is configured to: assess a probability of presence of the event or the element by an implementation of the neural network, implement the neural network according to the nominal mode when the probability of the presence of the event or the element is greater than a threshold, and implement the neural network according to the low power mode when the probability of the presence of the event or the element is below the threshold.

According to another aspect, a microcontroller is proposed including: a memory in which a program is stored as previously described, and a processor configured to execute the program.

### BRIEF DESCRIPTION OF THE DRAWINGS

For a more complete understanding of the present disclosure and the advantages thereof, reference is now made to the following descriptions taken in conjunction with the accompanying drawings, in which:

FIG. 1 is a block diagram of an embodiment microcontroller; and

FIG. 2 is a flow chart of an embodiment method for detecting events or elements.

### DETAILED DESCRIPTION OF ILLUSTRATIVE EMBODIMENTS

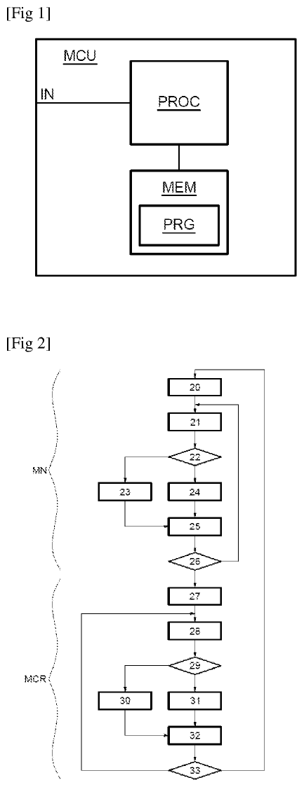

FIG. 1 illustrates an embodiment microcontroller MCU configured to be able to be supplied with energy by a battery (not represented). The microcontroller MCU is configured to implement a method for detecting events or elements in one physical signal or several physical signals. For example, the detection method can detect objects or people in images. The microcontroller MCU includes an input IN configured to receive the physical signal.

In embodiments, the physical signal is an image of a scene acquired by a camera.

The microcontroller MCU includes a memory MEM in which a program PRG is stored for execution by an artificial neural network to detect events or elements in the physical signal received as input IN. In particular, the microcontroller MCU includes a processor PROC configured to execute the program PRG by the artificial neural network.

Thus, the neural network can take a physical signal in which events or elements can occur as an input and generate detection data as output.

In embodiments, in response to the input physical signal being an image and an objective is to detect objects in the physical signal, the output detection data of the neural network can be a probability of the presence of the object at a given location, a size of this object, a position of the centre of this object, even a class of this object, or a combination thereof.

In embodiments, the neural network is a multi-resolution neural network. In such embodiments, the neural network has a single weight set but is configured to take as input physical signals, which can have different resolutions.

For example, the neural network can take as input images of different resolutions. In particular, the images can be provided to the microcontroller by a camera (not represented in the figures). The camera can then be adapted to change the resolution of the acquired images. Alternatively, the microcontroller can be configured to change the resolution of an image transmitted by the camera to obtain an image with a reduced resolution.

Alternatively, the physical signal can be an audio signal delivered by a microphone or a signal from an accelerometer, a gyroscope, a magnetometer, or a time of flight sensor.

In embodiments, the neural network is a network that has been trained by taking physical signals of different resolutions as input. The neural network is trained by taking as input physical signals with a nominal resolution and physical signals with a reduced resolution. The reduced resolution is a resolution lower than the nominal resolution. One or more reduced resolutions can be used for the physical signals received as input of the neural network. When the physical signals are images, the nominal resolution generally corresponds to a nominal resolution of the camera, allowing the acquisition of these images.

The neural network's performance can be assessed according to the different resolutions of physical signals received as input. The training is used to define a neural network whose performance is optimal for the nominal resolution and the least degraded possible for the reduced resolution. More particularly, when training the neural network, the weights of the neural network are adjusted, then the performance of the changed network is assessed according to the different resolutions used. If the performance of the neural network is satisfactory, the network training is stopped and the neural network can be quantified to reduce memory cost and execution time of the neural network.

Moreover, the neural network is configured to receive as input a physical signal having a resolution different from the resolution of the output data of the neural network. The neural network thus has a given ratio between the nominal input resolution and the output resolution of the neural network when it takes, as input, a physical signal with this nominal resolution. The resolutions that can be taken as the input of the neural network are then multiples of this ratio to obtain an actual resolution as the neural network's output for each resolution that can be taken as input.

In an embodiment, where the physical signal is an image, if the nominal resolution is 224×224 and the ratio between the nominal input resolution and the output resolution of the neural network is 16, then the neural network can take as input reduced resolutions multiple of 16, and in particular the following resolutions: 208×208, 192×192, 176×176.

Herein, the neural network can be implemented according to two modes of operation.

In a first mode, called nominal mode, the neural network is executed by taking as input a physical signal having the nominal resolution. In a second mode, called low power mode, the neural network is executed by taking as input a physical signal having a reduced resolution relative to the nominal resolution.

Executing the neural network in the low power mode requires fewer calculations than executing it in the nominal mode. Executing the neural network in the low power mode thus reduces its energy consumption relative to the nominal mode. For example, by dividing the resolution of an image by a number γ, it is possible to divide the number of operations to be performed by a number close to γ². In this manner, the execution time of the neural network is also divided by a number close to γ². Thus, the energy consumption resulting from the execution of the neural network is reduced.

FIG. 2 illustrates an embodiment state diagram representing a method for detecting events or elements which the microcontroller can implement.

The method consists of executing the neural network in the nominal mode when the probability of the presence of an event or an element is high and executing the neural network according to the low power mode when the likelihood of the presence of an event or an element is reduced.

In embodiments, the neural network is executed according to the nominal mode MN in the upper portion of the diagram and] the low power mode MCR in the lower portion of the diagram.

The probability of the presence of an event or an element is assessed from the number of detections obtained over a given period.

In particular, the microcontroller uses a buffer memory Sb[ ] to count the number of events or elements detected over a period T1 for the nominal mode and a period T2 for the low power mode. The periods T1 and T2 can be the same.

Thus, the method includes step 20 for initializing the nominal mode in which the buffer Sb[ ] is reinitialized by setting the values Sb[0] to Sb[T1−1] to 0.

Then, the method includes step 21 of executing the neural network according to the nominal mode. The neural network then takes as input a physical signal with the nominal resolution. The execution of the neural network allows detecting, in step 22, the presence or absence of the event or the element in the input physical signal. If the neural network detects the presence of the event or the element in the physical signal for an iteration i, then the buffer Sb[i] value is set to 1 in step 23. If the neural network detects an absence of the event or the element in the physical signal for an iteration i, then the buffer Sb[i] value is set to 0 in step 24. Then, the value of the index i is incremented in step 25 following step 23 or 24.

Then, the microcontroller checks that the buffer is full in step 26. If the buffer is not full, steps 21 to 25 are repeated to fill the buffer at the end of period T1. When the buffer is full, the microcontroller is configured to compare, also in step 26, the average value of the values of the buffer Sb[ ] with a threshold K1 defined between 0 and 1. If this average value is greater than the threshold K1, then the probability that the event or the element is indeed present is high, the neural network then continues to be executed according to the nominal mode over a new period T1. Steps 21 to 26 are therefore repeated as long as the average value of the buffer values at the end of a period T1 are greater than the threshold K1.

If the average value of the buffer values at the end of a period T1 are less than the threshold K1, then the neural network is executed according to the low power mode.

In embodiments, the method includes step 27 for initializing the low power mode in which the buffer Sb[ ] is reinitialized by setting the values Sb[0] to Sb[T2−1] to 0.

Then, the method includes step 28 of executing the neural network according to the low power mode. The neural network then takes as input a physical signal with the reduced resolution. In step 29, the neural network's execution allows detecting the presence or absence of the event or the element in the input physical signal. If the neural network detects the presence of the event in the physical signal for iteration i, then the value of the buffer Sb[i] is set to 1 in step 30. If the neural network detects an absence of the event or the element in the physical signal for an iteration i, then the buffer Sb[i] value is set to 0 at step 31. Then, the value of the index i is incremented in step 32 following step 30 or 31.

Then, the microcontroller checks that the buffer is full in step 33. If the buffer is not full, steps 28 to 32 are repeated to fill the buffer at the end of period T2. When the buffer is full, the microcontroller is configured to compare; also, in step 33, the average value of the values of the buffer Sb[ ] with a threshold K2 defined between 0 and 1. If this average value is less than the threshold K2, then the probability that the event or the element is indeed present is low; the neural network then continues to be executed according to the low power mode over a new period T2. Steps 28 to 33 are reiterated as long as the average value of the buffer values at the end of a period T2 are below the threshold K2.

If the average value of the buffer values at the end of period T2 is greater than the threshold K2, then the neural network is executed according to the nominal mode, reiterating the method from step 20.

The K1 and K2 thresholds can be adjusted according to the application for which the neural network is executed. In embodiments, the thresholds K1 and K2 are selected depending on a sensitivity (“recall”) or a desired accuracy. Nevertheless, it is advantageous to have a threshold K1 greater than a false alarm threshold in order to avoid detecting events or elements absent from the physical signal, which would prevent the execution of the neural network in the low power mode.

It is also possible to adjust the periods T1 and T2 depending on the time of the day, in particular if the presence of events or elements at certain times of the day is a priori more likely than at other moments. The periods T1 and T2 can also be adjusted according to the remaining capacity of the battery powering the microcontroller. The periods T1 and T2 can also be adjusted according to the remaining capacity of the battery powering the microcontroller or also according to the darkness around the camera when the physical signal is an image. The periods T1 and T2 can also be adjusted from statistics calculated from the frequency of the detections obtained by implementing the detection method in the environment in which the physical signal is captured.

Moreover, when the physical signals received as input of the neural network are a series of images generated by a camera, it is possible to reduce the number of images per second generated by the camera when the neural network is executed according to the low power mode to also reduce the energy consumption required by the use of the camera.

Of course, the method described is not limited to the described embodiments. In particular, it is possible to change the detection method described above such that if the neural network in the low power mode detects several events or elements in the same input physical signal (in particular, several objects in the same image), then the neural network is then directly executed according to the nominal mode without waiting for the end of the period T2. Indeed, detecting several events or elements in the same input physical signal increases the probability of a real presence of at least one event or element in this input physical signal. Likewise, it is possible to directly execute the neural network according to the nominal mode without waiting for the end of the period T2 when two elements to be detected are superimposed in the physical signal (in particular in an image) so as to increase the resolution of the physical signal to improve the detection of these two elements.

Furthermore, in the above description, the neural network is implemented by a microcontroller. Nevertheless, it is also possible to provide other computer systems which can implement the neural network.

A computer-readable non-transitory media includes all types of computer readable media, including magnetic storage media, optical storage media, flash media and solid state storage media.

It should be understood that software can be installed in and sold with a device. Alternatively the software can be obtained and loaded into a device, including obtaining the software through physical medium or distribution system, including, for example, from a server owned by the software creator or from a server not owned but used by the software creator. The software can be stored on a server for distribution over the Internet, for example.

Although the description has been described in detail, it should be understood that various changes, substitutions, and alterations may be made without departing from the spirit and scope of this disclosure as defined by the appended claims. The same elements are designated with the same reference numbers in the various figures. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

The specification and drawings are, accordingly, to be regarded simply as an illustration of the disclosure as defined by the appended claims, and are contemplated to cover any and all modifications, variations, combinations, or equivalents that fall within the scope of the present disclosure.

What is claimed is:

1. A method, comprising:
determining a probability of a presence of an event or an element using an artificial neural network having a single weight set, an input to the artificial neural network being a physical signal capable of having different resolutions;
executing the artificial neural network in a nominal mode of operation in response to the probability of the presence of the event or the element being greater than a threshold, the physical signal in the nominal mode being a physical signal having a nominal resolution; and
executing the artificial neural network in a low power mode of operation in response to the probability of the presence of the event or the element being less than the threshold, the physical signal in the low power mode being a physical signal having a reduced resolution lower than the nominal resolution.

2. The method of claim 1, wherein the reduced resolution is a multiple of a ratio between the nominal resolution and an output resolution based on an input having the nominal resolution.

3. The method of claim 2, wherein the threshold is based on a sensitivity of the artificial neural network.

4. The method of claim 2, wherein the threshold is based on a desired accuracy of the artificial neural network.

5. The method of claim 2, wherein the physical signal is an image.

6. The method of claim 1, wherein the threshold is greater than a false alarm threshold to avoid detecting events or elements absent from the physical signal.

7. The method of claim 1, wherein the artificial neural network is implemented in a microcontroller.

8. A non-transitory computer-readable media storing computer instructions, that when executed by a processor, cause the processor to:
determine a probability of a presence of an event or an element using an artificial neural network having a single weight set, an input to the artificial neural network being a physical signal capable of having different resolutions;
execute the artificial neural network in a nominal mode of operation in response to the probability of the presence of the event or the element being greater than a threshold, the physical signal in the nominal mode being a physical signal having a nominal resolution; and
execute the artificial neural network in a low power mode of operation in response to the probability of the presence of the event or the element being less than the threshold, the physical signal in the low power mode being a physical signal having a reduced resolution lower than the nominal resolution.

9. The non-transitory computer-readable media of claim 8, wherein the reduced resolution is a multiple of a ratio between the nominal resolution and an output resolution based on an input having the nominal resolution.

10. The non-transitory computer-readable media of claim 9, wherein the threshold is based on a sensitivity of the artificial neural network.

11. The non-transitory computer-readable media of claim 9, wherein the threshold is based on a desired accuracy of the artificial neural network.

12. The non-transitory computer-readable media of claim 9, wherein the physical signal is an image.

13. The non-transitory computer-readable media of claim 8, wherein the threshold is greater than a false alarm threshold to avoid detecting events or elements absent from the physical signal.

14. The non-transitory computer-readable media of claim 8, wherein the artificial neural network is implemented in a microcontroller.

15. A microcontroller, comprising:
a non-transitory memory storage comprising instructions; and
a processor in communication with the non-transitory memory storage, the execution of the instructions by the processor cause the processor to:
determine a probability of a presence of an event or an element using an artificial neural network having a single weight set, an input to the artificial neural network being a physical signal capable of having different resolutions;
execute the artificial neural network in a nominal mode of operation in response to the probability of the presence of the event or the element being greater than a threshold, the physical signal in the nominal mode being a physical signal having a nominal resolution; and
execute the artificial neural network in a low power mode of operation in response to the probability of the presence of the event or the element being less than the threshold, the physical signal in the low power mode being a physical signal having a reduced resolution lower than the nominal resolution.

16. The microcontroller of claim 15, wherein the reduced resolution is a multiple of a ratio between the nominal resolution and an output resolution based on an input having the nominal resolution.

17. The microcontroller of claim 16, wherein the threshold is based on a sensitivity of the artificial neural network.

18. The microcontroller of claim 16, wherein the threshold is based on a desired accuracy of the artificial neural network.

19. The microcontroller of claim 16, wherein the physical signal is an image.

20. The microcontroller of claim 15, wherein the threshold is greater than a false alarm threshold to avoid detecting events or elements absent from the physical signal.
